(19) United States
(12) Patent Application Publication
(10) Pub. No.: US 2018/0207776 A1
(43) Pub. Date: Jul. 26, 2018

(54) Pulling Systems and Methods

(71) Applicant: Tiger Tool International Incorporated, Abbotsford (CA)

(72) Inventor: Michael Andrews, Bellingham, WA (US)

(21) Appl. No.: 15/520,196

(22) PCT Filed: Oct. 23, 2015
(86) PCT No.: PCT/IB2015/002481

§ 371 Date: Apr. 19, 2017

Related U.S. Application Data
(60) Provisional application No. 62/068,389, filed on Oct. 24, 2014.

(51) Int. Cl. B25B 27/00; B25B 27/02

(52) U.S. Cl. CPC B25B 27/0035; B25B 27/14; B25B 27/023

(57) ABSTRACT

A pulling device for displacing a first object relative to a second object. A threaded body is threaded onto the threaded shaft. A positioning body is supported for movement along the shaft axis. A threaded body pivot connects the intermediate arm to the threaded body. An intermediate pivot pivotably connects the intermediate arm to the jaw arm. A positioning body pivot pivotably connects the jaw arm to the positioning body. With the threaded shaft in contact with the second object, displacement of the positioning body away from the threaded body causes the jaw arm to rotate such that a jaw of the jaw arm moves towards the shaft axis and engages the first object. Axial rotation of the threaded shaft displaces the threaded body in a pulling direction with the jaw in engagement with the first object displaces the first object relative to the second object.

### RELATED APPLICATIONS

This application (Attorney's Ref. No. P218463us) is a 371 of International PCT Application No. PCT/IB2015/002481 filed Oct. 23, 2015, currently pending.

International PCT Application No. PCT/IB2015/002481 claims benefit of U.S. Provisional Application Ser. No. 62/068,389 filed Oct. 24, 2014, now expired.

The contents of all related applications cited above are incorporated herein by reference.

### TECHNICAL FIELD

This disclosure relates to the field of screw-type pullers to pull one part linearly off of another part. In a more limited range, one example of the apparatus is used to remove a Pitman arm from a steering box shaft. The device may also be used to remove sway bars, tie rods etc. which are attached via (spline) shafts and compression devices.

### SUMMARY

The present invention may be embodied as a pulling system for displacing a first object relative to a second object, the pulling system comprising a threaded shaft, a threaded body, a positioning body, at least one intermediate arm, at least one jaw arm at least one threaded body pivot, at least one intermediate pivot, and at least one positioning body pivot. The threaded shaft defines a shaft axis. The threaded body is threaded onto the threaded shaft such that axial rotation of the threaded shaft relative to the threaded body displaces the threaded body relative to the threaded shaft along the shaft axis. The positioning body is supported for movement along the shaft axis relative to the threaded body. The at least one jaw arm defines a jaw. The at least one threaded body pivot pivotably connects the at least one intermediate arm to the threaded body. The at least one intermediate pivot pivotably connects the at least one intermediate arm to the at least one jaw arm. The at least one positioning body pivot pivotably connects the at least one jaw arm to the positioning body. Displacement of the positioning body towards the threaded body causes the at least one jaw arm to rotate such that the jaw of the at least one jaw arm moves away from the shaft axis. With the threaded shaft in contact with the second object, displacement of the positioning body away from the threaded body causes the at least one jaw arm to rotate such that the jaw of the at least one jaw arm moves towards the shaft axis and engages the first object and axial rotation of the threaded shaft displaces the threaded body and the positioning body in a pulling direction away from the second object, where displacement of the threaded body in the pulling direction with the at least one jaw in engagement with the first object displaces the first object relative to the second object.

The present invention may also be embodied as a method of displacing a first object relative to a second object comprising the following steps. A threaded shaft defining a shaft axis is provided. A threaded body is threaded onto the threaded shaft such that axial rotation of the threaded shaft relative to the threaded body displaces the threaded body relative to the threaded shaft along the shaft axis. A positioning body is supported for movement along the shaft axis relative to the threaded body. At least one threaded body pivot is arranged to pivotably connect at least one intermediate arm to the threaded body. At least one intermediate pivot is arranged to pivotably connect at least one intermediate arm to the at least one jaw arm. At least one positioning body pivot is arranged to pivotably connect the at least one jaw arm to the positioning body, where the at least one jaw arm defines at least one jaw. Displacing the positioning body towards the threaded body to cause the at least one jaw arm to rotate such that the jaw of the at least one jaw arm moves away from the shaft axis. With the threaded shaft in contact with the second object, displacing the positioning body away from the threaded body to cause the at least one jaw arm to rotate such that the jaw of the at least one jaw arm moves towards the shaft axis and engages the first object and axially rotating the threaded shaft to displace the threaded body and the positioning body in a pulling direction away from the second object, where displacement of the threaded body in the pulling direction with the threaded shaft in engagement with the second object and the at least one jaw in engagement with the first object displaces the first object relative to the second object.

The present invention may also be embodied as a pulling device for displacing a first object relative to a second object, the pulling device comprising a threaded shaft, a threaded body, a positioning body, first and second intermediate arms, first and second jaw arms, first and second threaded body pivots, first and second intermediate pivots, and first and second positioning body pivots. The threaded shaft defines a shaft axis. The threaded body is threaded onto the threaded shaft such that axial rotation of the threaded shaft relative to the threaded body displaces the threaded body relative to the threaded shaft along the shaft axis. The positioning body is supported for movement along the shaft axis relative to the threaded body. The first and second jaw arms each defining a jaw. The first and second threaded body pivots pivotably connect the first and second intermediate arms, respectively, to the threaded body. The first and second intermediate pivots pivotably connect the first and second intermediate arms to the first and second jaw arms, respectively. The first and second positioning body pivots are arranged on opposite sides of the shaft axis to pivotably connect the first and second jaw arms to the positioning body. Displacement of the positioning body towards the threaded body causes the first and second jaw arms to rotate such that the jaws of the first and second jaw arms moves away from the shaft axis. With the threaded shaft in contact with the second object, displacement of the positioning body away from the threaded body causes the first and second jaw arms to rotate such that the jaws of the first and second jaw arms move towards the shaft axis and engage the first object and axial rotation of the threaded shaft displaces the threaded body and the positioning body in a pulling direction away from the second object, where displacement of the threaded body in the pulling direction with the threaded shaft in engagement with the second object and the first and second jaws in engagement with the first object displaces the first object relative to the second object.

### BRIEF DESCRIPTION OF THE DRAWINGS

FIG. 1 is a bottom isometric view of one example of the apparatus;

FIG. 2 is a top isometric view of the example shown in FIG. 1;

FIG. 3 is a highly schematic bottom plan view;

FIG. 4 is a front plan view of the example shown in FIG. 1;

FIG. 5 is a front view of a prior art pitman arm puller;

FIG. 6 is a top isometric view of the pitman arm puller of FIG. 5 in use; and

FIG. 7 is a side view of another example of a prior art pitman arm puller in use.

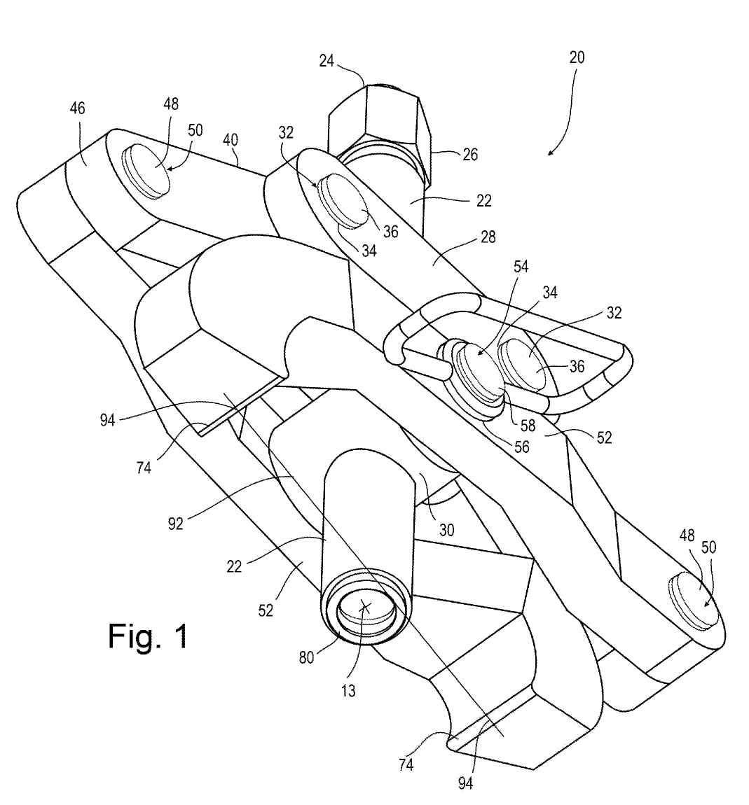

### DETAILED DESCRIPTION

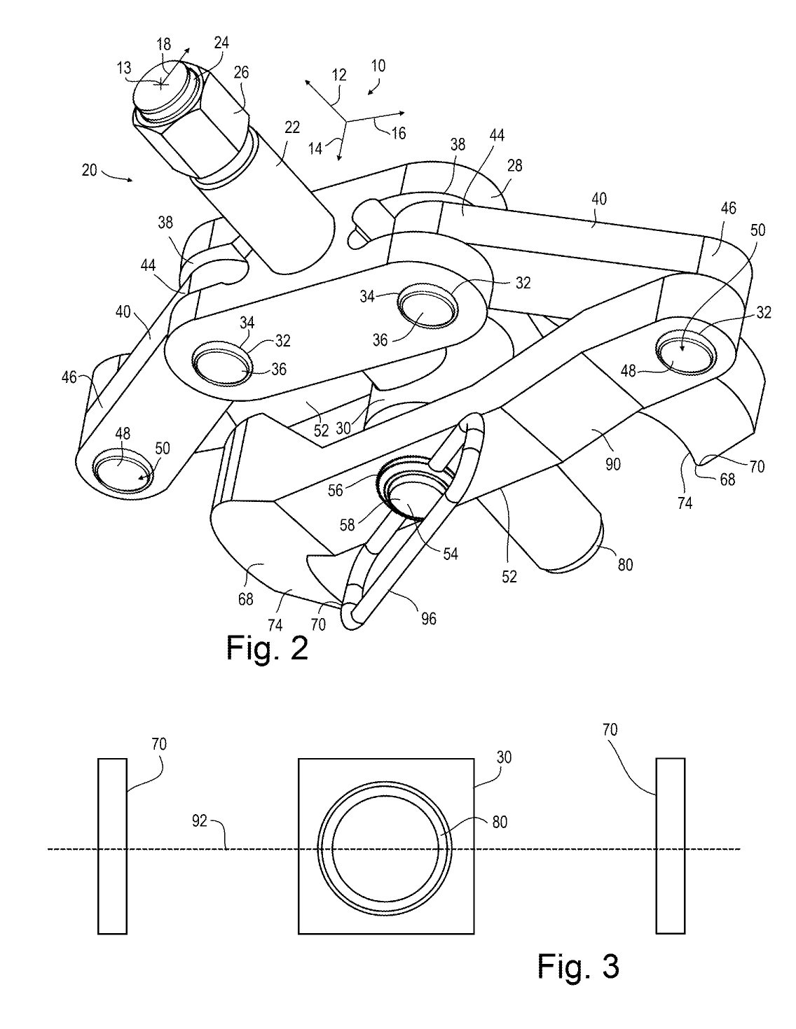

Looking to FIG. 2, an isometric view of the apparatus is shown. To aid in explaining the components and relative positions thereof, axes system 10 is shown. The axes system 10 comprising a longitudinal axis 12 generally aligned with the axis of rotation 13 of the threaded main shaft. The axes system 10 also comprising a lateral axis 14 which is orthogonal to the longitudinal axis 12 and generally aligned with the pivoting axis of a plurality of pivots described later. In addition, a transverse axis 16 is shown orthogonal to each of the longitudinal axis 12 and the lateral axis 14. Lastly, a radial axis 18 is shown centered upon the longitudinal axis 13.

The universal Pitman arm puller 20 is shown herein in several examples. The components of which may be interchanged by one of ordinary skill in the art.

Beginning with a detailed description of the threaded shaft 22, a first end 24 of the threaded shaft 22 includes a non-cylindrical nut 26. The non-cylindrical nut 26 in the illustration of FIG. 2 is shown having a hexagonal-flat-sided nut 26 which allows for attachment of many common wrenches such as box end wrenches, open end wrenches, socket wrenches well-known in the field of automotive maintenance and repair. Other surfaces can be utilized provided that a corresponding lever arm such as a wrench, screwdriver etc. can be attached to the non-cylindrical nut 26 for rotation thereof substantial force. The non-cylindrical nut 26 can even be provided by way of a surface defining a hole through which a rod or similar implement can be passed to provide rotational torque to the threaded shaft 22.

In the example shown in FIG. 3, a substantial portion of the shaft 22 is threaded so as to engage threaded surfaces on an upper body 28 and a lower body 30.

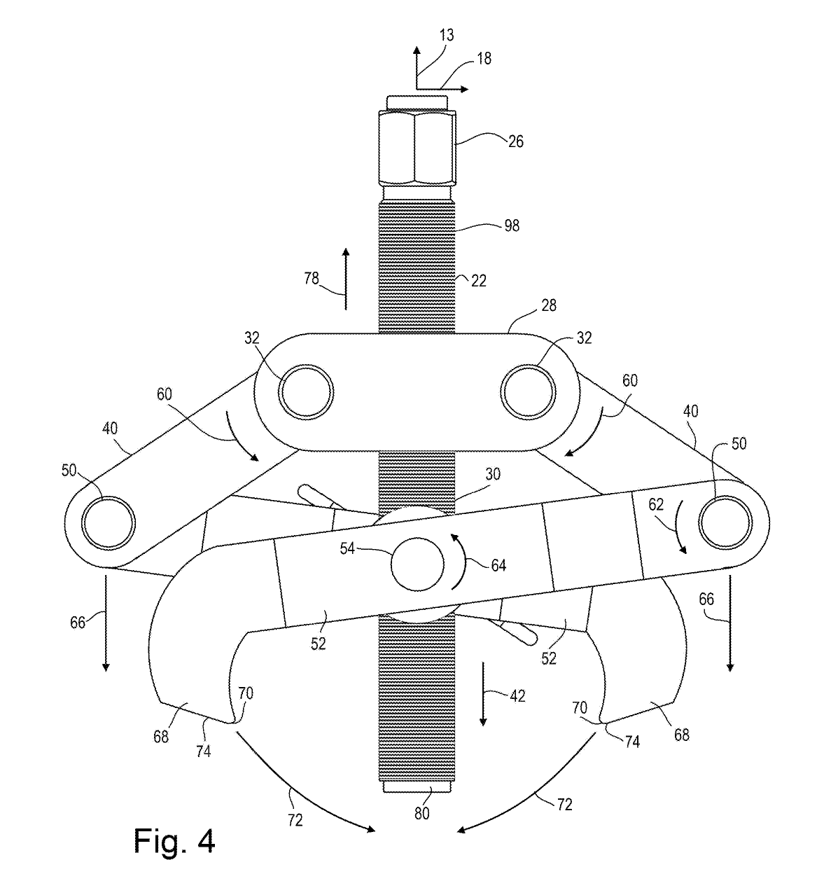

The upper body 28 and/or lower body 30 are longitudinally positionable along the shaft 22 by rotating the shaft 22 relative to either or by longitudinally sliding either the upper body 28 and/or lower body 30 along the threads so as to position the device correctly about a Pitman arm or associated apparatus for removal thereof. For example, an apparatus may be provided in the lower body 30 to allow the lower body 30 to selectively engage or disengage the threads of the threaded shaft 22. The lower body 30 may then be longitudinally moved downward 42 as shown in FIG. 4 independent of the upper body 28.

On each transverse end of the upper body 28 is provided an upper body pivot 32. In one form, the upper body pivots 32 are formed by way of a surface 34 defining a void through the upper body 28 into which is fitted a pin 36. The pin 36 passes through the upper body 28. In the example shown, a slot 38 is provided in each transverse end of the upper body 28. Into the slot 38 is placed one end of an upper arm 40.

The first end 44 of each upper arm 40 has a surface defining a void there through which allows attachment of the upper arms 40 to the upper body 28 via the pins 36. This allows for rotational movement of the upper arm 40 relative to the upper body 28. Similarly, the second and 46 of each upper arm 40 has a surface defining a void 46a there through. A pin 48 is passed through this surface defining the void forming an outer pivot 50 in the second end 46 of each upper arm 40.

A jaw arm 52 is attached to each lateral side of the lower body 30 by way of a lower body pivot 54 on either lateral side of the upper body 28. The lower body pivots 54 are co-axial in that the axes of rotation are aligned and parallel.

The lower body pivots 54 comprising a surface defining a void 56 through each of the jaw arms 52 into which is positioned a pin 58 which also engages the lower body 30. In one form, the pin 58 is a unitary structure with the lower body 30. To allow longitudinal movement of the lower body 30 relative to the shaft 22, it is generally not desired for the pin 58 to pass through the threaded shaft 22.

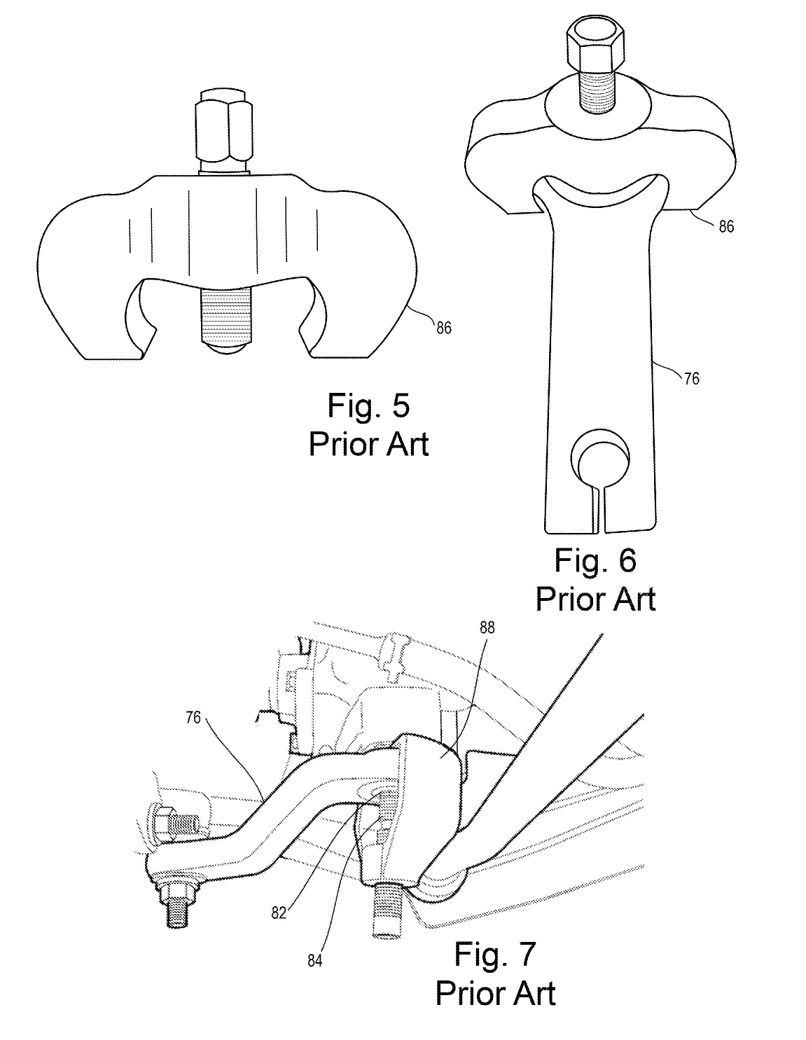

Looking to FIG. 4, it can be understood that downward movement 42 of the lower body 30 relative to the upper body 28 results in rotational movement 60 of the upper arms 40 relative to the upper body 28. As the upper arms 40 rotate about the upper pivots 32 the jaw arms 52 rotate relative to the upper arms 40 about the outer pivots 50 and the jaw arms 52 rotate relative to the lower body 30 about the lower body pivots 54. Overall, this movement results in downward movement 66 of the outer pivots 50 as well as the jaw ends 68 of the jaw arms 52. The net movement of the engagement teeth 70 follows the path 72 about the pivot 54 and simultaneously downward in direction 66. This path 72 allows the jaws 74 to grasp a Pitman arm 76 as shown in FIGS. 6, 7 or equivalent components. As the contact point 80 of the shaft 22 contacts a shaft 84, pin, or other components fitted into a cylindrical void 82 of the Pitman arm 76. Removal of such Pitman arms is well-known in the art such as by the prior art tools 86 and 88 shown in FIGS. 5-7.

The term Pitman arm is used herein is a common use for this particular part, however it is to be understood that the tool can be utilized for removal and installation of other parts. The term Pitman arm will be used in this disclosure for ease in description.

Once the jaws 74 are in the correct position about the Pitman arm 76, a tool is utilized to engage the non-cylindrical nut 26 and rotate the threaded shaft 22 relative to the upper body 28 and lower body 30. This rotation of the shaft relative to the threaded upper body 28 and lower body 30 results in upward longitudinal linear movement 78 of the upper body 28, lower body 30, and jaw arms 52, relative to the shaft 22 due to the inner threaded surfaces of the upper body 28 and/or lower body 30.

Looking specifically to FIG. 2, it can be seen how the contact surfaces between the jaw arm 52 and the upper arm 40 are offset from a plane 92 parallel to the axis 13 of the shaft 22 and perpendicular to the pivots 32, 50, and 54. In this example, the jaw arm 52 comprises a bend 90 between the outer pivot 50 in the lower body pivot 54 so as to properly engage the lower body 30. Likewise, as can be seen in the highly schematic view of FIG. 2, the plane 92 passes through the axis 13 of the threaded shaft 22, is perpendicular to the pivots 32, 50, and 54, and (substantially) passes through the lateral centers 94 of each jaw 74.

This alignment of the jaws 74 through the plane 92, in combination with the arrangement of the jaw arms 52 provides a much stronger and more easily adjustable device than that shown in prior art devices.

Also shown is a handle 96 which may be used to position or carry the universal Pitman arm puller 20. The handle in one example may be used to control linear movement of the lower body 30 by selectively engaging the threads 98 on the shaft 22 upon movement of the handle 96 relative to the lower body 30.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

What is claimed is:

1. A pulling device for displacing a first object relative to a second object, the pulling device comprising:
a threaded shaft defining a shaft axis;
a threaded body threaded onto the threaded shaft such that axial rotation of the threaded shaft relative to the threaded body displaces the threaded body relative to the threaded shaft along the shaft axis;
a positioning body supported for movement along the shaft axis relative to the threaded body;
at least one intermediate arm;
at least one jaw arm defining a jaw;
at least one threaded body pivot for pivotably connecting the at least one intermediate arm to the threaded body;
at least one intermediate pivot for pivotably connecting the at least one intermediate arm to the at least one jaw arm;
at least one positioning body pivot for pivotably connecting the at least one jaw arm to the positioning body; wherein
displacement of the positioning body towards the threaded body causes the at least one jaw arm to rotate such that the jaw of the at least one jaw arm moves away from the shaft axis; and
with the threaded shaft in contact with the second object,
displacement of the positioning body away from the threaded body causes the at least one jaw arm to rotate such that the jaw of the at least one jaw arm moves towards the shaft axis and engages the first object, and
axial rotation of the threaded shaft displaces the threaded body and the positioning body in a pulling direction away from the second object, where displacement of the threaded body in the pulling direction with the at least one jaw in engagement with the first object displaces the first object relative to the second object.

2. A pulling device as recited in claim 1, further comprising:
first and second intermediate arms;
first and second jaw arms defining a first and second jaws, respectively; and
first and second threaded body pivots for pivotably connecting the first and second intermediate arms to the threaded body, respectively;
first and second intermediate pivots for pivotably connecting the first and second intermediate arms to the first and second jaw arms, respectively;
first and second positioning body pivots for pivotably connecting the first and second jaw arms to the positioning body; wherein
displacement of the positioning body towards the threaded body causes the first and second jaw arms to rotate such that the first and second jaws move away from the shaft axis; and
with the threaded shaft in contact with the second object,
displacement of the positioning body away from the threaded body causes the first and second jaw arms to rotate such that the first and second jaws move towards the shaft axis and engage the first object, and
axial rotation of the threaded shaft displaces the threaded body and the positioning body in a pulling direction away from the second object, where displacement of the threaded body in the pulling direction with the threaded shaft in engagement with the second object and the first and second jaws in engagement with the first object displaces the first object relative to the second object.

3. A pulling device as recited in claim 2, in which the first and second positioning body pivots are arranged on opposite sides of the shaft axis.

4. A pulling device as recited in claim 3, in which:
a reference plane aligned with the shaft axis is substantially symmetrically arranged between the first and second positioning body pivots; and
the first and second jaws are substantially symmetrical about the reference plane.

5. A pulling device as recited in claimed 1, in which the threaded body defines at least one slot; wherein
a portion of the at least one intermediate arm is arranged in the at least one slot; and
the at least one threaded body pivot extends through the portion of the at least one intermediate arm arranged in the at least one slot.

6. A pulling device as recited in claimed 2, in which the threaded body defines first and second slots; wherein
a portion of the first intermediate arm is arranged in the first slot;
a portion of the second intermediate arm is arranged in the second slot;
the first threaded body pivot extends through the portion of the first intermediate arm arranged in the first slot; and
the second threaded body pivot extends through the portion of the second intermediate arm arranged in the second slot.

7. A pulling device as recited in claim 1, in which:
the at least one threaded body pivot comprises at least one threaded body pin extending through at least a portion of the threaded body and at least a portion of the at least one intermediate arm;
the at least one intermediate pivot comprises at least one intermediate pin extending through at least a portion of the at least one intermediate arm and at least a portion of the at least one jaw arm; and
the at least one positioning body pivot comprises at least one positioning body pin extending from the positioning body and through at least a portion of the at least one jaw arm.

8. A pulling device as recited in claim 2, in which:
the first and second threaded body pivots comprise first and second threaded body pins extending through first and second portions of the threaded body and at least a portion of the first and second intermediate arms, respectively;
the at least one intermediate pivot comprises
a first intermediate pin extending through at least a portion of the first intermediate arm and at least a portion of the first jaw arm, and
a second intermediate pin extending through at least a portion of the second intermediate arm and at least a portion of the second jaw arm; and
the first and second positioning body pivots comprise first and second positioning body pins extending from the positioning body and through at least a portion of the first and second jaw arms, respectively.

9. A method of displacing a first object relative to a second object, the method comprising the steps of:
providing a threaded shaft defining a shaft axis;
threading a threaded body onto the threaded shaft such that axial rotation of the threaded shaft relative to the threaded body displaces the threaded body relative to the threaded shaft along the shaft axis;
supporting a positioning body for movement along the shaft axis relative to the threaded body;
arranging at least one threaded body pivot to pivotably connect at least one intermediate arm to the threaded body;
arranging at least one intermediate pivot to pivotably connect at least one intermediate arm to the at least one jaw arm;
arranging at least one positioning body pivot to pivotably connect the at least one jaw arm to the positioning body, where the at least one jaw arm defines at least one jaw;
displacing the positioning body towards the threaded body to cause the at least one jaw arm to rotate such that the jaw of the at least one jaw arm moves away from the shaft axis;
with the threaded shaft in contact with the second object,
displacing the positioning body away from the threaded body to cause the at least one jaw arm to rotate such that the jaw of the at least one jaw arm moves towards the shaft axis and engages the first object, and
axially rotating the threaded shaft to displace the threaded body and the positioning body in a pulling direction away from the second object, where displacement of the threaded body in the pulling direction with the threaded shaft in engagement with the second object and the at least one jaw in engagement with the first object displaces the first object relative to the second object.

10. A method as recited in claim 9, further comprising the steps of:
arranging first and second threaded body pivots to pivotably connect first and second intermediate arms to the threaded body, respectively;
arranging first and second intermediate pivots to pivotably connect first and second intermediate arms to the first and second jaw arms, respectively, where the first and second jaw arms define first and second jaws, respectively;
arranging first and second positioning body pivots to pivotably connect the first and second jaw arms to the positioning body;
displacing the positioning body towards the threaded body to cause the first and second jaw arms to rotate such that the first and second jaws move away from the shaft axis; and
with the threaded shaft in contact with the second object,
displacing the positioning body away from the threaded body to cause the first and second jaw arms to rotate such that the first and second jaws move towards the shaft axis and engage the first object, and
axially rotating the threaded shaft to displace the threaded body and the positioning body in a pulling direction away from the second object, where displacement of the threaded body in the pulling direction with the threaded shaft in engagement with the second object and the first and second jaws in engagement with the first object displaces the first object relative to the second object.

11. A method as recited in claim 10, further comprising the step of arranging the first and second positioning body pivots on opposite sides of the shaft axis.

12. A method as recited in claim 11, further comprising the steps of:
defining a reference plane aligned with the shaft axis and substantially symmetrically arranged between the first and second positioning body pivots; and
configuring the first and second jaws such that the first and second jaws are substantially symmetrical about the reference plane.

13. A method as recited in claim 9, in which the threaded body defines at least one slot, the method further comprising the steps of:
arranging a portion of the at least one intermediate arm in the at least one slot; and
extending the at least one threaded body pivot through the portion of the at least one intermediate arm arranged in the at least one slot.

14. A method as recited in claim 10, in which the threaded body defines first and second slots, the method further comprising the step of:
arranging a portion of the first intermediate arm in the first slot;
arranging a portion of the second intermediate arm in the second slot;
extending the first threaded body pivot through the portion of the first intermediate arm arranged in the first slot; and
extending the second threaded body pivot through the portion of the second intermediate arm arranged in the second slot.

15. A method as recited in claim 9, in which:
the step of arranging the at least one threaded body pivot comprises the step of extending at least one threaded body pin through at least a portion of the threaded body and at least a portion of the at least one intermediate arm;
the step of arranging the at least one intermediate pivot comprises the steps of extending at least one intermediate pin through at least a portion of the at least one intermediate arm and at least a portion of the at least one jaw arm; and
the step of arranging the at least one positioning body pivot comprises the step of extending at least one positioning body pin from the positioning body and through at least a portion of the at least one jaw arm.

16. A method as recited in claim 10, in which:
the step of arranging the first and second threaded body pivots comprises the step of extending first and second threaded body pins through first and second portions of the threaded body and at least a portion of the first and second intermediate arms, respectively;
the step of arranging at least one intermediate pivot comprises the steps of
extending a first intermediate pin through at least a portion of the first intermediate arm and at least a portion of the first jaw arm, and
extending a second intermediate pin through at least a portion of the second intermediate arm and at least a portion of the second jaw arm; and
the step of arranging the first and second positioning body pivots comprises the step of extending first and second positioning body pins from the positioning body and through at least a portion of the first and second jaw arms, respectively.

17. A pulling device for displacing a first object relative to a second object, the pulling device comprising:
a threaded shaft defining a shaft axis;
a threaded body threaded onto the threaded shaft such that axial rotation of the threaded shaft relative to the threaded body displaces the threaded body relative to the threaded shaft along the shaft axis;
a positioning body supported for movement along the shaft axis relative to the threaded body;
first and second intermediate arms;
first and second jaw arms each defining a jaw;
first and second threaded body pivots for pivotably connecting the first and second intermediate arms, respectively, to the threaded body;
first and second intermediate pivots for pivotably connecting the first and second intermediate arms to the first and second jaw arms, respectively;
first and second positioning body pivots arranged on opposite sides of the shaft axis for pivotably connecting the first and second jaw arms to the positioning body; wherein
displacement of the positioning body towards the threaded body causes the first and second jaw arms to rotate such that the jaws of the first and second jaw arms moves away from the shaft axis; and
with the threaded shaft in contact with the second object,
displacement of the positioning body away from the threaded body causes the first and second jaw arms to rotate such that the jaws of the first and second jaw arms move towards the shaft axis and engage the first object, and
axial rotation of the threaded shaft displaces the threaded body and the positioning body in a pulling direction away from the second object, where displacement of the threaded body in the pulling direction with the threaded shaft in engagement with the second object and the first and second jaws in engagement with the first object displaces the first object relative to the second object.

18. A pulling device as recited in claim 17, in which:
a reference plane aligned with the shaft axis is substantially symmetrically arranged between the first and second positioning body pivots; and
the first and second jaws are substantially symmetrical about the reference plane.

19. A pulling device as recited in claimed 17, in which the threaded body defines first and second slots; wherein
a portion of the first intermediate arm is arranged in the first slot;
a portion of the second intermediate arm is arranged in the second slot;
the first threaded body pivot extends through the portion of the first intermediate arm arranged in the first slot; and
the second threaded body pivot extends through the portion of the second intermediate arm arranged in the second slot.
